(19) United States
(12) Patent Application Publication
(10) Pub. No.: US 2016/0016835 A1
(43) Pub. Date: Jan. 21, 2016

(54) Mobile Wastewater Treatment System with Human Use Facility and Recycle

(71) Applicant: Jerry L. McKinney, Silsbee, TX (US)

(72) Inventor: Jerry L. McKinney, Silsbee, TX (US)

(21) Appl. No.: 14/335,188

(22) Filed: Jul. 18, 2014

(51) Int. Cl. C02F 9/00

(52) U.S. Cl. CPC C02F 9/00; C02F 3/1236

(57) ABSTRACT

A mobile wastewater treatment system wherein a mobile carrier has mounted thereon a wastewater treatment plant and a pump tank. There is a pump disposed in the pump tank, the output in the pump being selectively directed to a human use facility. Discharge from the human use facility is transferred by gravity to a lift station, accumulated wastewater at the lift station being transferred to the input of the wastewater treatment plant.

### FIELD OF THE INVENTION

The present invention relates to wastewater treatment systems and, more particularly, to a mobile wastewater treatment system including a human use facility with recycle.

### DESCRIPTION OF THE PRIOR ART

Hurricane Katrina highlighted the need for mobile, easily transportable temporary wastewater treatment facility which can be rapidly deployed and quickly made operational. While disasters such as Hurricane Katrina underscore the need for such wastewater treatment systems, there are numerous other situations in which such systems are highly desirable and in many cases, mandatory. For example, at remote oil and gas well sites, wastewater treatment systems meeting regulatory compliance standards are often mandatory to comply with environmental protection laws. In particular, as is well known considerable amounts of water are used in fracing operations which is the procedure now used extensively in the recovery of oil and gas. There is increasing public concern over the usage of water in fracing operations and accordingly companies engaged in the practice make every effort to recover and reuse the water to the extent possible. None the less, much of the water cannot be economically reclaimed and is usually sent to disposal wells. Ironically, many of the most productive oil and gas formations where fracing is necessary for recovery are located in aired areas of the country. Accordingly conservation of water is paramount.

Further saving of water such systems are also desired and in many cases mandatory at mining locations, marine facilities and can also be used in events where human use facilities, e.g., toilets, are needed, e.g., camping sites, festivals, etc. where fixed human use facilities are not available.

### SUMMARY OF THE INVENTION

In one aspect, the present invention provides a portable wastewater treatment facility, including one or more human use facilities.

In another aspect, the present invention provides a mobile wastewater treatment system including at least one human use facility with recycle.

In still a further aspect, the present invention provides a portable wastewater treatment system having human use facilities wherein used water can be recycled and/or safely discharged to the environment.

These and further features and advantages of the present invention will become apparent from the following detailed description, wherein reference is made to the figures in the accompanying drawings.

### BRIEF DESCRIPTION OF THE DRAWINGS

FIG. 1 is an elevational view of the mobile wastewater treatment system including a human use facility in accordance with one aspect of the present invention.

FIG. 2 is an elevational view showing in greater detail the system of FIG. 1.

FIG. 3 is an elevational view showing another embodiment of the mobile wastewater treatment system of the present invention.

FIG. 4 is a schematic view of an apparatus for introducing a liquid disinfecting agent into wastewater such as can be safely discharged to the environment.

FIG. 5 is an elevational view of another embodiment of the present invention.

### DETAILED DESCRIPTION OF PREFERRED EMBODIMENTS

As will be seen hereafter, the term “wastewater treatment plant” or similar terms refers to a system which can treat raw sewage or the like so as to produce a discharge which after UV disinfection can be used at some human use facilities and/or alternatively with further disinfection can be discharged to the environment. Thus, wastewater treatment plants contemplated by the present invention include, but are not limited to, aerobic wastewater treatment systems, packaged activated sludge fixed film treatment systems, etc.

The term “lift station” is intended to include any system by which water can be moved from a lower elevation to a higher elevation and can include pumps, gas lifts, storage vessels, floats, valves, etc.

The term “carrier” as used herein is intended to include any structure which can be moved from site to site over highways and the like and which can include a skid removably mounted on a trailer, a trailer itself, a truck bed or any other of a variety of carriers which can be moved either under their own motive power or pulled by another vehicle, e.g., a tractor-trailer, truck or the like.

The term “human use facility” includes toilets, urinals, sinks, showers, etc. where substantially disinfected water is necessary as opposed to human use facilities dispensing potable water where bacteria free water is necessary.

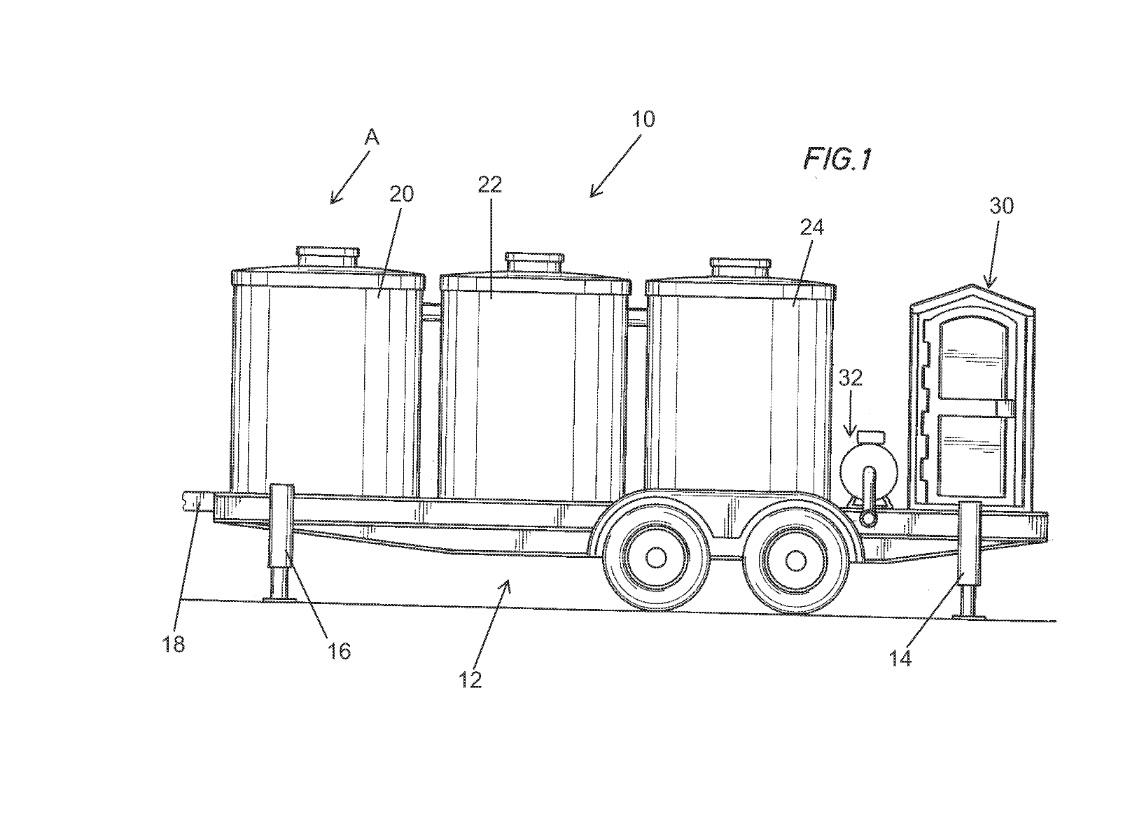

Referring now to FIG. 1, one embodiment of the mobile wastewater treatment system of the present invention is shown. The wastewater treatment system shown generally as 10 comprises a carrier which as shown in FIG. 1 is a wheeled trailer shown generally as 12, trailer 12 having outriggers 14 and 16 which are typically hydraulic jacks or the like which can be used to position the trailer 12 at a desired location and keep it stationary. Although not shown, it will be understood that trailer 12 could be pulled by a truck, tractor trailer, or the like via a tongue 18 in a well known manner.

The system 10 shown in FIG. 1 utilizes an aerobic wastewater treatment plant shown generally as A and in this regard comprises a settling or pretreatment tank 20, and an aerobic treatment tank 22. There is also a pump tank 24 on carrier 12. As seen, suitable piping connects pretreatment tank 20 to aerobic treatment tank 22 while other suitable piping connects aerobic tank 22 to pump tank 24.

Also mounted on trailer 12 is a toilet facility 30 for housing a urinal, commode, sink or the like, as seen hereafter. There is a lift station shown, generally as 32 and described more fully hereafter also mounted on carrier 12.

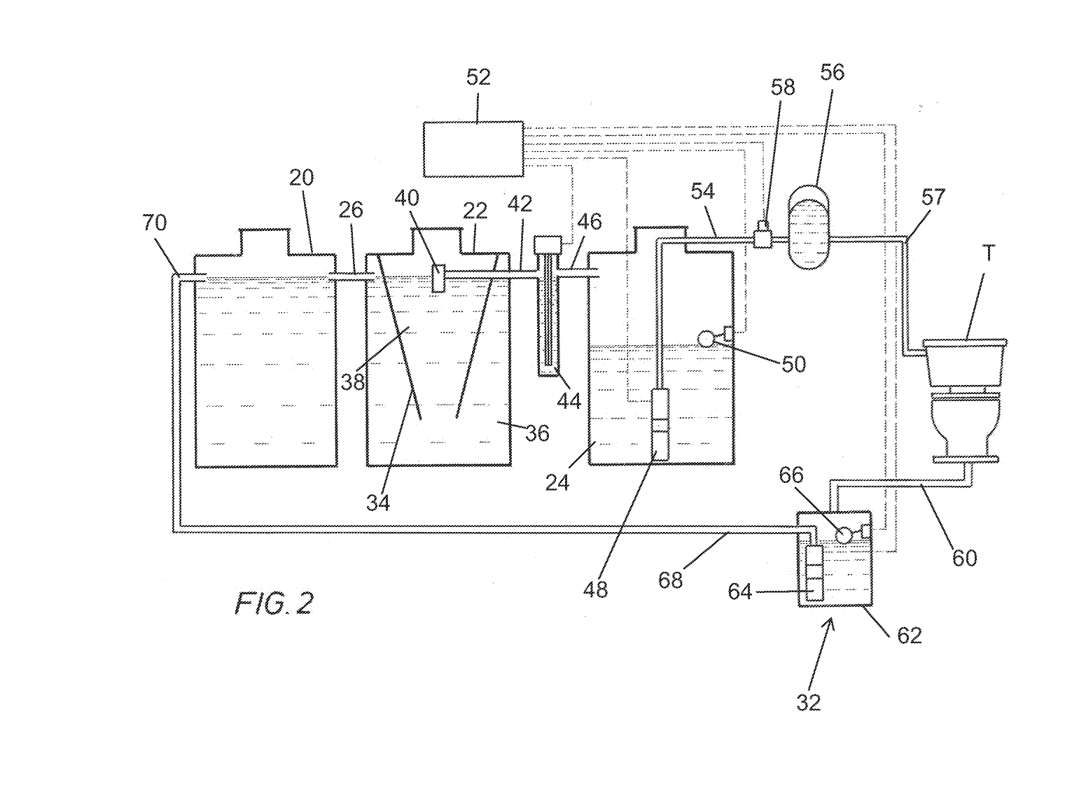

Referring now to FIG. 2, the operational aspects of the system shown in FIG. 1 are described more fully. As is well known to those skilled in the art, in aerobic wastewater treatment plants such as shown in FIG. 2, pretreatment tank 20 acts, in one respect, as a settling tank to allow undigestable solids to settle out and be later removed. In any event, water from tank 20 passes via gravity through line 26 and into aerobic treatment tank 22. As is well known, a typical aerobic treatment tank has a frustroconical partition 34 which divides aerobic treatment tank 22 into an aerobic treatment chamber 36 and a clarifier chamber 38. Although not shown, it will be appreciated that a source of oxygen, e.g., air, is pumped into the aerobic treatment chamber 36 whereby undigested solids carried over from pretreatment tank 20 are aerobically digested. Clarifier chamber 38 acts to allow any undigested solids to settle out back into aerobic treatment chamber 36 for further digestion. Substantially clarified water is removed from clarifier chamber 38 via gravity overflow 40 and passes via line 42 into UV disinfectant apparatus 44. Apparatus 44 is of a type well known to those skilled in the art and is typified by the Salcor UV Disinfection Unit marketed by ANUA-US. The UV disinfection apparatus 44 has a UV light source mounted in the center of an anodized aluminum frame which divides the chamber in half. When inserted, this subassembly causes the wastewater entering from line 42 to flow vertically downward, make a 180° turn and then flow vertically upward and out the other side of the unit, in this case via line 46. The UV disinfected water flows into pump tank 24. As is typical of pump tanks commonly used with wastewater treatment systems, there is a pump 48 disposed in pump tank 24 and a high level float assembly shown generally as 50. Pump tank 48 is connected to a controller 52 which along with supplying power also controls pump 48. Float 50 is also connected to controller 52. It will be understood that the system shown in FIG. 2 is a closed loop system wherein water that is used in a human use facility, e.g., toilet T, is recycled through the system.

Disposed between toilet T and pump tank 24 is a bladder tank 56 and pressure switch 58, switch 58 being located between pump 48 and bladder tank 56. Pressure switch 58 monitors the pressure in bladder tank 56. When the system is quiescent bladder tank 56 is pressured to the desired amount, and there is no flow of water through the closed loop system shown in FIG. 2. However, once toilet T is flushed, bladder tank 56 empties and pressure switch 58 now detects low pressure in bladder tank 56. Pressure switch 58 then communicates with controller 52 to activate pump 48 so as to pump water into bladder tank 56 until the desired pressure is reached as sensed by pressure switch 58 at which point pump 48 is again deactivated. Generally speaking, in the system shown in FIG. 2, high level float 50 serves no substantial purpose since the volume of water passing through the closed system is substantially fixed. Accordingly, there is essentially no water lost from the system since it is all recycled. In this regard, reference is again made to FIG. 2. When toilet T is flushed, the flushed wastewater passes via gravity through line 60 into lift station 32.

As shown in FIG. 2, lift station 32 comprises a tank 62 in which is disposed pump 64 and a float 66. Flushed water passing from toilet T via line 60 into tank 62 accumulates until it reaches the level at which float 66 is activated which in turn, via controller 52 sends a signal to pump 64 to turn on and pump water in tank 62 via line 68 back to the input 70 of pretreatment tank 20. It will be understood that when float 66 reaches a certain, lower level, pump 64 will then be deactivated via controller 54 and the system will again remain static until further use. It will be understood that toilet T or any human use facility will always be positioned relative to lift station 32 such that water will flow by gravity into lift station 32.

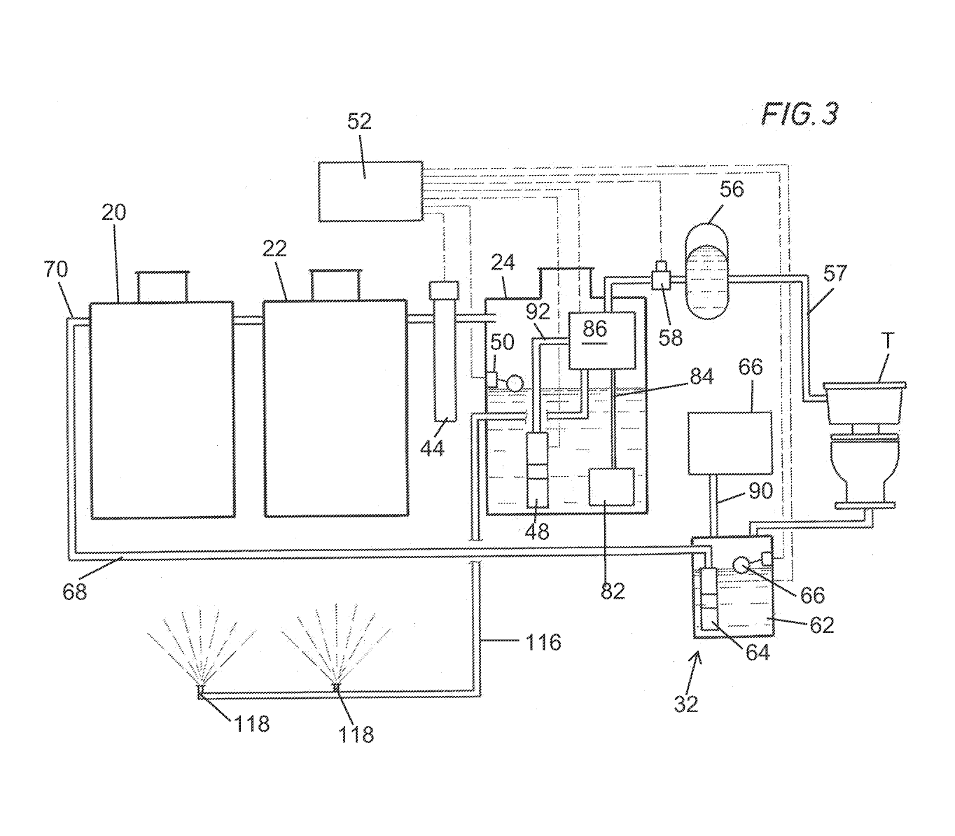

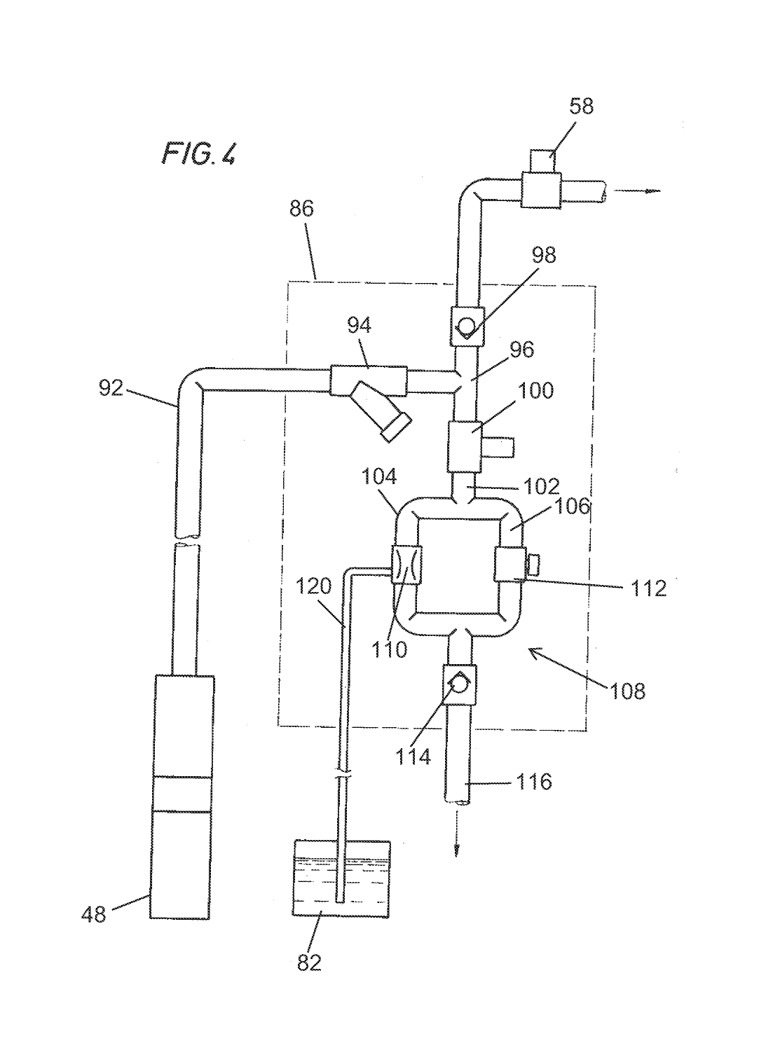

Turning now to FIGS. 3 and 4, there is shown another embodiment of the wastewater treatment system of the present invention. The system depicted in FIGS. 3 and 4 is one that provides both for recycle and for discharge of treated water to the environment, e.g., a stream, spray irrigation, etc. Further, the system in FIG. 3 depicts a satellite human use facility 80 which again can be a toilet such as toilet T, a sink or the like as described above. As seen in FIG. 3, satellite human use facility 80 is schematically shown as being located above the level of lift station 32 to further point out the need for gravity flow from the human use facility to lift station 32 or a respective lift station connected to satellite human use facility 80.

Disposed in pump tank 24 is a liquid disinfecting agent tank 82 which is connected by line 84 to a flow circuit indicated as 86 in FIG. 3 but shown in greater detail in FIG. 4. In this regard, the flow circuit 86 is shown in the dotted rectangle of FIG. 4. With respect to the function of the system shown in FIG. 3, when toilet T is flushed, the same operation as described above with respect to FIG. 2 occurs. In other words, water flushed from toilet T flows by gravity via line 60 into lift station 32. In like manner, water from satellite, human use facility 80 will also flow by gravity via line 90 to lift station 32 or to a separate lift station. If it is assumed that satellite human use facility 80 is connected to lift station 32 along with toilet T, when use is made of human use facility 80, water will flow via line 90 as discussed above into tank 62 of lift station 32. At such time that the water level reaches a certain height, float 66 via controller 52 will activate pump 64 and send water in tank 62 to the input 70 of pretreatment tank 20. It will be understood that in the arrangement depicted in FIG. 3, rather than it being a closed loop system, there is additional wastewater being introduced into the system from the satellite human use facility 80. Accordingly, ultimately the water level in pump tank 24 will reach a level at which float 50, via controller 52, will activate pump 48 which will pump water via line 92 through a filter 94, e.g., a spin filter and into tee 96. Tee 96 is connected on one end to check valve 98 which is disposed upstream of pressure switch 58. The other end of tee 96 is connected to solenoid valve 100 which in turn is connected via pipe 102 to branch lines 104 and 106 of a metering system shown generally as 108. Metering system 108 comprises a venturi 110 in branch line 104 and a control valve 112 in branch line 106. The output from either branch lines 104 and 106 passes through a check valve 114 to sprinkler heads 118 via line 116 whereby water can be discharged to the environment. However, under most environmental regulations, water discharged from a wastewater treatment system into the environment must be treated to ensure that the bacteria levels are as low as possible. To this end, venturi 110 is connected to line 120 which extends into liquid disinfecting agent tank 82.

In operation, when the level of water in pump tank 24 activates float switch 50, and it is necessary to discharge water to the environment, float 50 via controller 52 will activate pump 48 which will pump water via line 92 through spin filter 94 and alternately into bladder tank 56 if pressure switch 58 indicates the pressure in bladder tank 56 is too low or through the metering system 108. In this regard although a solenoid valve 100 is shown, it is not totally necessary. However, when a solenoid valve such as valve 100 is used it can be activated by controller 52 to open line 102 in the metering system 108. It will be understood that in the normal case, solenoid valve 100 is opened and remains open on a timed basis. In other words, if it was desired to discharge water to the environment, a timer in controller 52 would open solenoid valve 100 and keep it open for a predetermined amount of time until the water level in pump tank 24 reached the desired level. Typically, the solenoid valve would be opened at night and the water sprayed or otherwise disposed to the environment such as is commonly done in residential wastewater treatment systems. The water then flowing through metering system 108 will flow through venturi 110. Using throttling valve 112, the flow of water through venturi 110 can be controlled such that the proper amount of liquid disinfecting agent is added to the water to be discharged to the environment, e.g., via sprinklers 118. It will be noted that with the presence of check valves 98 and 114, no back flow can occur. In other words, once water is pumped past check valve 98 or check valve 114, it cannot flow in the other direction.

As discussed, so long as pressure switch 58 senses sufficient water pressure in bladder tank 56, no water will flow into bladder tank 56. However, as noted above, if the water in pump tank 24 reaches a sufficiently high level, water will then be discharged to the environment via the metering system 108, check valve 114, line 116, and sprinklers 118.

Although in the embodiment shown in FIGS. 3 and 4, a single lift station is connected both to toilet T and to satellite human use facility 80, it will be understood that if there were multiple satellite human use facilities, each one could be in association with a lift station such as lift station 32 such that a respective human use facility had a respective lift station 32. However, even in these cases the water from tank 62 forming part of lift station 32 will still be pumped into pretreatment tank 20 as described above flowing through the system as described with respect to the description of the operation of the system shown in FIGS. 3 and 4 such that both recycle and/or discharge to the environment can occur.

Pumping of wastewater to the environment is a function of the amount of water in the pump tank, i.e., when the high-level float is at its maximum upper position it sends a signal to the controller which in turn sends a signal to the pump in the pump tank which then pumps water out through the metering system for spraying or other discharge, e.g. into streams. In other words, if there is only a single human use facility as shown in FIG. 2, then closed loop total recycle is possible, but if there are multiple human use facilities feeding into the system, then at times the pump tank will become overloaded with liquid in which case it will have to be discharged to the environment.

It will be appreciated that the ability to have recycle minimizes the amount of makeup water that may be needed. It should also be recognized that where there are multiple, satellite human use facilities, makeup water may be necessary to operate those human use facilities and that that water for the most part will be discharged to the environment after being properly treated with liquid disinfecting agent as described above.

Thus the mobile wastewater treatment system of the present invention can provide either a single, closed loop system wherein there is adequate wastewater treatment and a human use facility or a mobile wastewater treatment plant that can be used to service multiple human use facilities albeit that in the latter case at least some of the water will be discharged to the environment as described above.

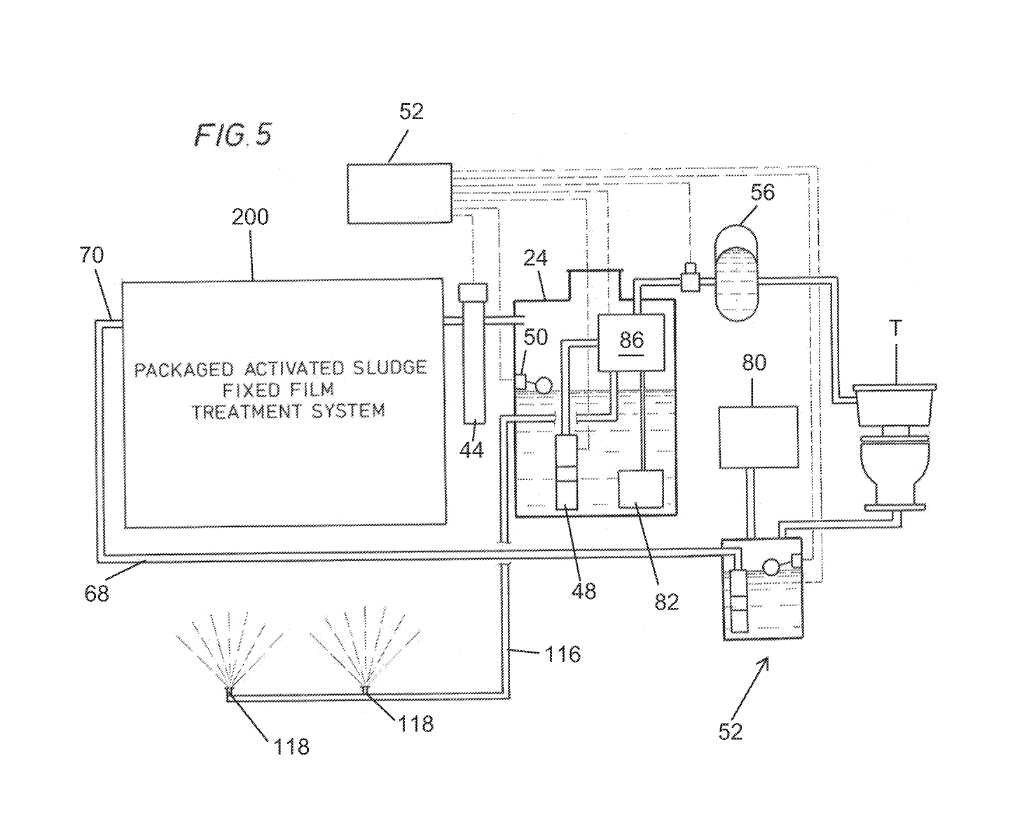

Referring now to FIG. 5, there is shown another embodiment of the present invention. The embodiment shown in FIG. 5 is identical in all respects to that shown and described in FIGS. 3 and 4 with the exception that instead of an aerobic wastewater treatment plant, packaged activated sludge fixed film treatment system 200 is used as the wastewater treatment plant. Activated sludge wastewater treatment plants are well known to those skilled in the art and comprise a process of treating wastewater using air and biological floc composed of bacteria and protozoans. The design, construction and operation of activated sludge fixed film treatment systems is well known to those skilled in the art and need not be discussed in further detail. Suffice to say that such a system is widely used and could be substituted for the aerobic wastewater treatment system shown and described with respect to FIGS. 1-4.

It is to be noted that in the basic disinfection of the wastewater, a UV irradiation source is employed. While such a disinfection system is sufficient for use in water in a closed loop system, such as shown in FIG. 2, because there is sufficient bacteria and microorganism kill such that the treated water poses no health hazards particularly if it is not used for drinking, cooking or the like, e.g., it is used for sinks, toilets, etc. If wastewater is ultimately to be discharged to the environment, environmental regulations generally require that further disinfecting occur. For this reason, a liquid disinfecting agent and a system to supply same to the water being discharged will be employed as described with particular respect to FIGS. 3 and 4. It is known that when wastewater is disinfected by UV, there is invariably at least several colonies of untreated bacteria. If this treated water is allowed to stand, e.g., in pump tank 24, these colonies multiply and the water becomes highly bacteria laden. This highlights the purpose of using a liquid disinfecting agent when it is desired to discharge water to the environment. However, so long as the human use facilities do not include potable water dispensers, UV irradiation is sufficient to lower the bacteria to a safe level.

Although specific embodiments of the invention have been described herein in some detail, this has been done solely for the purposes of explaining the various aspects of the invention, and is not intended to limit the scope of the invention as defined in the claims which follow. Those skilled in the art will understand that the embodiment shown and described is exemplary, and various other substitutions, alterations and modifications, including but not limited to those design alternatives specifically discussed herein, may be made in the practice of the invention without departing from its scope.

What is claimed is:

1. A mobile wastewater treatment system, comprising:
a carrier;
a wastewater treatment plant mounted on said carrier, said treatment plant having an input and an output;
a UV disinfecting apparatus, said UV disinfecting apparatus having an inlet connected to said output, and an outlet;
a pump tank, said pump tank connected to the outlet of said UV disinfecting apparatus;
a first pump disposed in said pump tank, said first pump having an output;
at least one human use facility, said human use facility being operatively connected to said output of said first pump; and
at least one lift station for transferring gravity flow, accumulated wastewater from said at least one human use facility to the input of said wastewater treatment plant.

2. The system of claim 1, wherein said wastewater treatment plant comprises an aerobic wastewater treatment plant.

3. The system of claim 1, wherein said wastewater treatment plant comprises an activated sludge fixed film treatment system.

4. The system of claim 1, wherein there are a plurality of said human use facilities operatively connected to said waste water treatment plant.

5. The system of claim 4, wherein each of said plurality of human use facilities is connected to a respective lift station.

6. The system of claim 1, including a disinfecting apparatus for introducing a liquid disinfectant into water discharged from said pump tank to the environment, said disinfecting apparatus comprising a storage tank for said liquid disinfectant and an apparatus for introducing said liquid disinfectant into said water being discharged to the environment.

7. The system of claim 6, wherein said apparatus for introducing said liquid disinfectant comprises a metering system.

8. The system of claim 7, wherein said metering system comprises a venturi connected to said liquid disinfectant storage tank and the output of said first pump.

9. The system of claim 8, wherein there is a filter disposed between said venturi and the output of said first pump.

10. The system of claim 1, wherein a bladder tank is connected to the output of said first pump and said human use facility.

11. The system of claim 10, wherein there is a pressure switch disposed between the output of said first pump and said bladder tank, said pressure switch opening in response to lowered pressure in said bladder tank to selectively turn on said first pump, when said pressure in said bladder tank falls below a predetermined a level.

12. The system of claim 1, wherein said at least one lift station comprises a holding tank for said gravity flow, accumulated wastewater from said human use facility and a second pump for transferring said accumulated wastewater to said input of said wastewater treatment plant.

13. The system of claim 8, wherein said metering system comprises an input and an output, a first branch line connected between said input and said output and a second branch line connected between said input and said output, said first branch line including said venturi, said second branched line including a control valve, said control valve controlling the amount of water flowing through said venturi.

14. The system of claim 7, wherein there is a solenoid valve disposed between said first pump and said metering system.

15. The system of claim 14, wherein said solenoid valve operates as a function of time and there is a controller operatively connected to said solenoid valve.

16. The system of claim 13, wherein there is a check valve in the output from said metering system.
